(19) United States
(12) Patent Application Publication
(10) Pub. No.: US 2017/0359187 A1
(43) Pub. Date: Dec. 14, 2017

(54) Scalable real-time videoconferencing over WebRTC

(71) Applicant: LogMeIn, Inc., Boston, MA (US)

(72) Inventors: Zolten Bettenbuk, Budapest (HU); Laszlo Luczo, Budapest (HU)

(21) Appl. No.: 15/620,910

(22) Filed: Jun. 13, 2017

Related U.S. Application Data
(60) Provisional application No. 62/349,183, filed on Jun. 13, 2016.

(51) Int. Cl. H04L 12/18; H04L 29/06; H04N 7/14

(52) U.S. Cl. CPC H04L 12/1827; H04N 7/147; H04L 65/608

(57) ABSTRACT

A WebRTC-compliant media server avoids sharing the SSRCs of passive participants (namely, the video viewers who do not send video) by intercepting feedback packets (issued from the viewers) on the server side, modifying those packets, and then transmitting the modified packets back to the sender such that, when the sender receives these feedback packets, the sender treats the packets as if they were sent by a known SSRC. Preferably, the known SSRC is one that is associated with a single SSRC (e.g., a dummy or surrogate SSRC, or a technical SSRC, in either event that was previously shared with the video sender). The sender knows how to handle these packets and can then send the desired answer to the viewer(s) to maintain the conference stable and operational even as the number of participants grows and exceeds the SSRC peer limitations.

### BACKGROUND

### Technical Field

This disclosure relates generally to video conferencing technologies, products and services.

### Background of the Related Art

Remote access technologies, products and systems enable a user of a remote computer to access and control a host computer over a network. Internet-accessible architectures that provide their users with remote access capabilities (e.g., remote control, file transfer, display screen sharing, chat, computer management and the like) also are well-known in the prior art. Typically, these architectures are implemented as a Web- or cloud-based “service,” such as LogMeIn®, and others. For basic “remote access,” an individual who uses the service has a host computer that he or she desires to access from a remote location. Using the LogMeIn software-as-a-service (SaaS), for example, the individual can access his or her host computer using a client computer or mobile device that runs a web browser or a mobile app. Such technologies also are leveraged to facilitate other network-based services, such as videoconferencing. Videoconferencing is the conduct of a video conference by a set of telecommunications technologies that allow two or more locations to communicate by simultaneous two-way video and audio transmissions. An exemplary Internet-based video conferencing service that is enabled as-a-service using a simple web browser is LogMeIn join.me. In this approach, a videoconference is accessed by an end user going to a URL sent by a meeting organizer.

Collaboration services such as described typically conform to WebRTC (see, e.g. www.webrtc.org for a reference implementation). WebRTC (Web Real-Time Communication) is an API definition drafted by the World Wide Web Consortium (W3C) that supports browser-to-browser applications for voice calling, video chat, and P2P file sharing without the need of either internal or external plugins. WebRTC is widely used for real-time videoconferencing due to its low latency connections and very smart logic in terms of handling receiver feedbacks (e.g. packet loss). This technology, however, was designed for peer-to-peer usage, although relay servers (like Jitsi Videobridge) allows WebRTC-based technologies to be used in client-server based applications. While WebRTC is widely-adopted, it has significant limitations. In particular, video participants (peers) in a videoconference that uses WebRTC technology have to have a source identifier (called SSRC) to identify packets sent over the network (see, RFC 1889). These SSRCs have to be shared across the conference participants to identify the others who are participating. If a peer receives a packet from another peer whose SSRC is not known on its side, then the peer may drop/ignore the packet, or there may be some other unintended behavior that can lead to unstable media transfer among the peers.

The WebRTC standard also imposes a hard-coded limit (namely, 64) on the SSRCs a particular peer is allowed to handle. That said, when a peer is handling a list of SSRCs that is bigger than, say, 10-15 (depending on the peer's hardware performance capabilities), its performance deteriorates. This, in turn, impacts the ability of the collaboration service to support a large number of participants. Thus, for example, when a join.me video session may support a large number (e.g., up to 250 video viewers), once more than 15-20 participants access the video meeting, the deficiencies inherent in WebRTC (namely, the SSRC limit) impact performance.

Thus, there remains a significant need to enable real-time video conferences to scale to a high number of participants while overcoming the limitations of the WebRTC standard.

### BRIEF SUMMARY

According to WebRTC, the sharing the SSRCs of video viewers (namely, the peers that only receive video) with the sender is necessary. In particular, this feedback has to be handled properly by the sender peer (e.g., before the sender sends a new keyframe) so that the viewer is able to decode the received media stream continuously (i.e. identify the received data and associate the received video with a particular (high level) user). That said, to solve the above-identified performance scaling problem, a computing entity (e.g., a server, or server group) that is managing the videoconference and its delivery according to this disclosure recognizes SSRCs of those participants who are only viewing the videoconference (as opposed to sending video), and then processes those SSRCs in a unique way.

In particular, and according to this disclosure, the server avoids sharing the SSRCs of the video viewers by intercepting feedback packets (issued from the viewers) on the server side, modifying those packets, and then transmitting the modified packets back to the sender such that, when the sender receives these feedback packets, the sender treats the packets as if they were sent by a known SSRC. Preferably, the known SSRC is one that is associated with a single SSRC (e.g., a dummy SSRC, or a technical SSRC, in either event that was previously shared with the video sender). The sender knows how to handle this packet and can then send the desired answer to the viewer to maintain the conference stable and operational even as the number of participants grows and exceeds the SSRC peer limitations.

Thus, according to the disclosure, the approach no longer identifies (to the sender) video viewer peers in a WebRTC-based videoconference with their own actual SSRCs, but rather minimizes the number of required SSRCs in a video meeting by capturing the feedback packets (from those viewer peers) and faking video packets back to the sender during network transfer. This approach may be implemented using a conventional video streaming server that is augmented (e.g., via a plug-in) to enable the functionality. By faking the packets between the two peers on the server side, the peer that receives the packets handles them as if there were sent by another known peer.

The foregoing has outlined some of the more pertinent features of the subject disclosure. These features should be construed to be merely illustrative. Many other beneficial results can be attained by applying the disclosed subject matter in a different manner or by modifying the subject matter as will be described.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 depicts an extensible Web- or cloud-based remote access and support architecture platform that may be used to facilitate the techniques of this disclosure;

FIG. 2 depicts the technique of this disclosure wherein an intermediary server hijacks viewer peer feedback packets and fakes packets back to the sender peer.

### DETAILED DESCRIPTION OF AN ILLUSTRATIVE EMBODIMENT

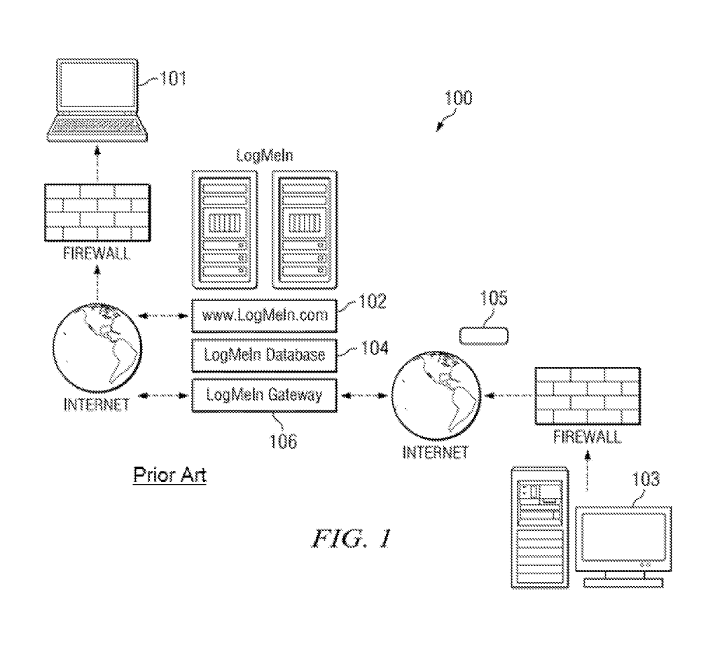

FIG. 1 illustrates a high level view of an on-demand architecture 100 in which the disclosed technique may be practiced. This architecture is merely representative, and it should not be taken as limiting. Preferably, the architecture comprises “n-tiers” that include a web server tier 102, a database tier 104, and a gateway tier 106. The web server tier 102 comprises a plurality of machines that each executes web server software. The web server tier provides an Internet-accessible web site. Preferably, the web site associated with a site domain (however designated) is available from multiple locations that collectively comprise the web server tier 102. The database tier 104 comprises a plurality of machines that each executes database server software. The database tier provides a network-accessible data storage service for generating and storing data associated with end user sessions to the remote access service. The gateway tier 106 comprises a plurality of machines that each executes application server software. The gateway tier provides a network-accessible connection service for establishing and maintaining connections between and among the participating end user computers. Although not shown, preferably end user computers connect to the gateway servers over secure connections, e.g., over SSL, TLS, or the like. A representative machine on which the web server, database server or gateway server executes comprises commodity hardware (e.g., one or more processors) running an operating system kernel, applications, and utilities.

Generalizing, one or more functions of such a technology platform may be implemented in a cloud-based architecture. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications).

The platform may comprise co-located hardware and software resources, or resources that are physically, logically, virtually and/or geographically distinct. Communication networks used to communicate to and from the platform services may be packet-based, non-packet based, and secure or non-secure, or some combination thereof.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

The architecture in FIG. 1 preferably supports a network-accessible service enables participating end users to collaborate with one another over a network. In such an approach, end users have computing devices (e.g., computers, mobile phone, tablet devices, or the like) that include hardware and software to enable the device to access a network, such as the public Internet, a Wi-Fi network connected to the Internet, a 3G or higher wireless network connected to the Internet, a private network, or the like. The network-accessible service provides a publicly-available site (such as a Web site) or a local software application from which a first participating end user initiates a “meeting,” e.g., by selecting a “share” button. In response, the site or software application provides an HTTP link that includes a “meeting” code. The meeting code may be a one-time unique code, or a meeting code associated with the user for repeat use. The first participating end user then shares the link with whomever he or she desires to collaborate. Upon receiving the link (e.g., by e-mail, instant message, SMS, MMS, orally, or the like), a second participating end user joins the meeting “on-the-fly” by simply selecting the link or navigating to the site and entering the “meeting” code (in a “join” field). The service provides an “instant connect” function that connects the second participating end user to the meeting immediately and without requiring any registration, software download, or the like. Upon completing a meeting, participants are provided an option to download the local software application from which (once installed on the local computer) subsequent meetings can be initiated or joined without requiring navigation to the site itself. Preferably, the actual connectivity between or among the participating end users is provided using a tiered server infrastructure (such as shown in FIG. 1) that provides a highly-available, scalable “join meeting” service that is easy to use, highly reliable, and secure.

The infrastructure provides for an unlimited number of meetings, and each meeting may include up to a large number (e.g., 250) participants.

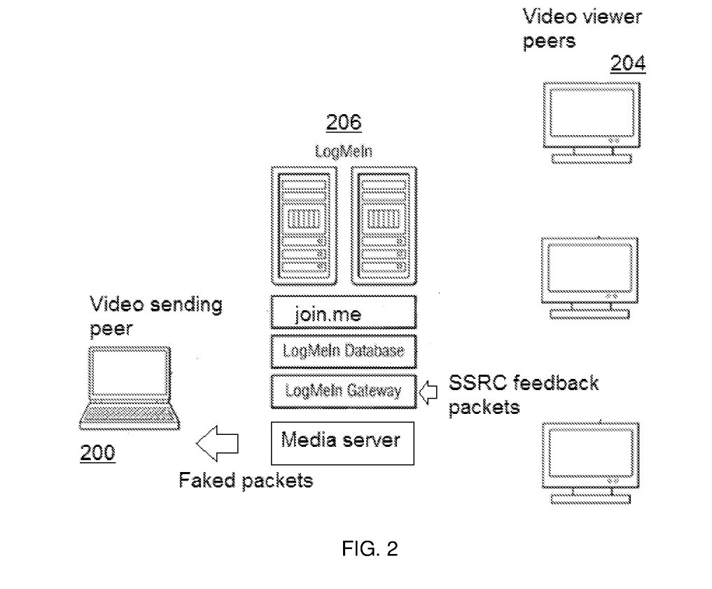

FIG. 2 depicts an operating environment in which the subject technique is practiced. In this example, a sender peer 200 has a camera and originates the videoconference, and receiving (viewer) peers 204 receive that video. The viewer peers 204 do not act to send video (although theoretically one of the peers 204 may assume responsibility for sending). The infrastructure 206 supports the videoconferencing using an architecture such as described in FIG. 1, together with the necessary WebRTC video support (depicted by the media server). The infrastructure 206 is shown in simplified form but may include multiple locations, each with multiple server clusters. For purposes of this disclosure, the components are WebRTC-compliant.

Thus, in one embodiment, the first participating end user (sender 200) accesses the service via a desktop or laptop computer. A representative machine is a data processing system that includes a communications fabric that provides communications between a processor unit, memory, persistent storage, a communications unit, an input/output (I/O) unit, and a display. A typical data processing system includes a web browser or the like that is WebRTC-compliant. Thus, a sender peer camera transfers a video in real-time to the display screens of the viewer peers via direct (peer-to-peer or “P2P”) connections. As noted, the stream delivery (video encoding and decoding, etc.) conforms to the WebRTC standard.

The Web Real-Time communication (WebRTC) framework provides the protocol building blocks to support direct, interactive, real-time communication using audio, video, collaboration, etc., between two peers' web-browsers. WebRTC uses the Real-time Transport Protocol (RTP) (RFC3550) as its media transport protocol. RTP provides a framework for delivery of audio and video teleconferencing data and other real-time media applications. According to WebRTC, the sharing the SSRCs of video viewers (namely, the peers that only receive video) with the sender is necessary. (SSRC is an identifier for an RTP synchronization source). In particular, this feedback has to be handled properly by the sender peer (e.g., before the sender sends a new keyframe) so that the viewer is able to decode the received media stream continuously (i.e. identify the received data and associate the received video with a particular (high level) user). That said, to solve the above-identified performance problem, a computing entity (e.g., a server, or server group) that is managing the videoconference and its delivery recognizes SSRCs of those participants who are only viewing the videoconference (as opposed to sending video), and then processes those SSRCs in a unique way.

In particular, and according to this disclosure, the server avoids sharing the SSRCs of the video viewers by intercepting these feedback packets on the server side, modifying those packets, and then transmitting the modified packets back to the sender such that, when the sender receives these feedback packets, the sender treats the packets as if they were sent by a known SSRC. Preferably, the known SSRC is one that is associated with a single SSRC (e.g., a dummy SSRC, or a technical SSRC, in either event that was previously shared with the video sender). The sender knows how to handle this packet and can then send the desired answer to the viewer to maintain the conference stable and operational even as the number of participants grows and exceeds the SSRC peer limitations.

Thus, according to the disclosure, the approach no longer identifies video viewer peers in a WebRTC-based videoconference with their own actual SSRCs, but rather minimizes the number of required SSRCs in a video meeting by capturing the feedback packets (from those viewer peers) and faking video packets back to the sender during network transfer. This approach may be implemented using a conventional video streaming server that is augmented (e.g., via a plug-in) to enable the functionality. By faking the packets between the two peers on the server side, the peer that receives the packets handles them as if there were sent by another known peer.

When multiple senders are present in the conference, the approach as described preferably is used for each of them.

The approach provides significant advantages. It enables scaling of the videoconference to well beyond a limited number of participants. Even as the conference scales up to a high participant count, the conference is stable and latency remains very low (e.g., under 2 seconds). The approach can be implemented whenever the use cases have one or only a few number of video senders, irrespective of the number of video viewers. Thus, the technique may be used to provide webinars, town-hall meetings, online classroom trainings, and the like.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

While given components of the system have been described separately, one of ordinary skill will appreciate that some of the functions may be combined or shared in given instructions, program sequences, code portions, and the like.

The described commercial products, systems and services are provided for illustrative purposes only and are not intended to limit the scope of this disclosure.

The techniques herein provide for improvements to technology or technical field, namely, on-demand remote access environments, as well as improvements to various technologies such as videoconferencing over a wide area network, and the like, all as described.

Having described our invention, what we claim is as follows:

1. Apparatus, comprising:
a processor;
computer memory holding computer program instructions executed by the processor during a videoconference established among a peer sender, and a plurality of peer viewers that are not senders, the computer program instructions operative to:
intercept WebRTC source identifier feedback packets issued from the plurality of peer viewers; and
in lieu of forwarding the intercepted WebRTC source identifier feedback packets to the peer sender, sending the peer sender feedback packets that appear to originate from a peer already known to the peer sender.

2. The apparatus as described in claim 1 wherein the WebRTC source identifier is a Real-time Transport Protocol (RTP) synchronization source identifier (SSRC).

3. The apparatus as described in claim 1 wherein the plurality of peer viewers exceeds twenty (20) peer viewers.

4. The apparatus as described in claim 1 wherein the plurality of peer viewers exceeds hundreds of peer viewers.

5. The apparatus as described in claim 1 wherein the peer already known to the peer sender has associated therewith a single WebRTC source identifier.

6. A method of videoconferencing among a peer sender, and a plurality of peer viewers that are not senders, comprising:
as a videoconference initiated by the peer sender is on-going, intercepting WebRTC source identifier feedback packets issued from the plurality of peer viewers; and
in lieu of forwarding the intercepted WebRTC source identifier feedback packets to the peer sender, sending the peer sender feedback packets that appear to originate from a surrogate peer already known to the peer sender.

7. The method as described in claim 6 wherein the WebRTC source identifier is a Real-time Transport Protocol (RTP) synchronization source identifier (SSRC).

8. The method as described in claim 6 wherein the plurality of peer viewers exceeds twenty (20) peer viewers.

9. The method as described in claim 6 wherein the plurality of peer viewers exceeds hundreds of peer viewers.

10. The method as described in claim 6 wherein the surrogate peer already known to the peer sender has associated therewith a single WebRTC source identifier.

11. The method as described in claim 6 further including providing the peer sender information identifying the surrogate peer in advance of the videoconference initiation.
